(19) United States
(12) Patent Application Publication
(10) Pub. No.: US 2009/0016496 A1
(43) Pub. Date: Jan. 15, 2009

(54) Communication system

(76) Inventor: Michael W. Bulmer, Lenexa, KS (US)

Correspondence Address: Michael W. Bulmer, P.O. BOX 14292, Shawnee Mission, KS, 66285, US

(21) Appl. No.: 11/879,145

(22) Filed: Jul. 14, 2007

(51) Int. Cl. H04M 11/04

(52) U.S. Cl. 379/45

(57) ABSTRACT

The communication system for use by law enforcement and emergency personnel is presented. The system includes a provider for providing analog and digital transmissions over a hybrid network. A blended call center disseminates and receives information related to a crime. The blended call center includes media applications for law enforcement and emergency personnel to communicate information over the hybrid network. A crime classification system tracks and classifies crimes to provide intelligence information. A plurality of mobile communication devices sends and receives messages over the hybrid network. A broadcasting means broadcasts information related to crimes over the hybrid network. An Internet site provides secure access to intelligence information. A conference monitor establishes a media conference with an operator at the blended call center. And, a server is in communication with the blended call center, wherein users of the communication system can access information for dissemination or receiving.

### CROSS-REFERENCE TO RELATED APPLICATIONS

The present Utility patent application claims priority benefit of the U.S. provisional application for patent Ser. No. 60/816,519 filed under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates to crime intelligence and, more particularly, to related advisories and communication systems.

### BACKGROUND OF THE INVENTION

In recent years there has been a problem with how crime information is classified, stored and disseminated. The problem is that crime statistics are gathered from law enforcement sources, and these law enforcement sources self report. Many times the figures that law enforcement sources report are inaccurate. One reason for this is that there is public pressure to reduce crime, and these law enforcement agencies are under the pressure of the public. Another shortfall of present methods is that the systems that gather the data have different classifications, and there is no universal classification method. Another shortfall of current reporting methods is that many crimes are not reported to authorities, but they are often reported to medical personal and archived at the medical examiners office.

Currently for the dissemination of crime information, there are alerts and TV programming that are very informative about wanted criminals. A problem with these methods is that the channels broadcasting the information rely on law enforcement, and law enforcement relies on these channels. There is no universal system where law enforcement broadcasts on its own to the public.

When it comes to criminal apprehensions, there have been no effective systems that enable law enforcement to communicate with each other during apprehension. When it comes to wireless communications, there are currently no systems that effectively communicate with law enforcement. There are emergency personnel radios that communicate with audio only. There are also cell phones and phone booths, but these devices do not enable users to see each other. Also, emergency centers are not connected to each other and do not have the capability to track the public properly. In addition all 911 centers are not connected into a single network that is private or non-private.

There are police radios; however, messages broadcast on these radios can be intercepted. Also, police have laptops; however, laptops are not good outside of an office or useful in a vehicle for the officer, for example, without limitation, when he is on foot patrol during public appearances, or outside the vehicle. The officer has to worry in public as the radio can be heard. Furthermore, there may be times when an officer needs to visually get a message, for example, without limitation, in the event that a terror suspect is present and the officer does not want to others to eavesdrop on the radio. There currently are emergency personnel scanners and members of the public who know 10 codes.

Currently there are several systems to classify crimes such as, but not limited to, self report surveys and the Uniform Crime Report (UCR). There has even been legislation to track medical records. The tracking of medical files to help with workman's compensation HIPPA, and also billing, under that system not intelligence-crime data mining, mine in this instance is to investigate crimes to be data mined for suspected crimes and data mining for intelligence. For example, if someone uses anthrax this system could be data mined to check everyone who had a certain medication or was treated a certain way or reported a crime to medical personnel. There have also been crime profile programs that profile criminals, but these programs do not provided the solution needed. A problem lies in these programs in that they are not available 24 hours a day 365 days a year. Also, these other crime programs are not consistent in programming. For example, without limitation, when Sep. 11, 2001 occurred, the media programs caused more panic than they helped with the situation because all they could do was show the planes flying into the buildings over and over again. This effected many things in a negative way. What is needed is a crime intelligence network that seeks to be more informative and helpful to the public and does not engage in scare tactics.

A problem with current solutions is that they do not track crime patterns and the information is not data mined at all or data mined properly because the information is not computerized. Furthermore, the UCR is not mandatory and relies on self-report from law enforcement agencies. The data in the UCR is tracked by region or city, and this can cause underreported statistics for various reasons, including, without limitation, poor public funding and work performance for law enforcement. Also, in many cases, the police do not want to admit there is a crime problem. In the case of medical providers, physicians and hospitals, the information is guarded under the HIPA medical privacy laws. Furthermore, reports to medical authorities often contradict police figures. One of the shortcomings of using third party media is that the police have often had bad experiences with the media in the past. In some cases, the media engages in improper reporting to inflate ratings or sell advertisers to programming. There has never been a network controlled by the police independently or through a third party. The police have been worried that the wrong information may be released or conveyed to the public, which hinders the investigation.

During times of disaster pet owners may become separated from their pets. In some cases these pets may be euthanized before the owner finds them, causing much grief for the owner. There have been attempts to reunite pets and owners after a disaster but theses attempts have not been that successful. For example, without limitation, there has been pet rescue kennels and microchips. Often in the past pet owners had limited options such as handing out fliers and calling local pet pounds or shelters. Some pet owners may have implanted microchips in their pets, but not everyone can afford these options in an emergency. There may also be restricted movements in an emergency. Therefore, these choices have been unacceptable for theses extra additions to the family.

In view of the foregoing, there is a need for an improved communication system that enables law enforcement to communicate discretely, accurately stores, classifies and disseminates crime information, and enables the tracking of crime. There is also a need for a communication system that may be used to track missing pets, for example, without limitation, in the case of an emergency or natural disaster.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary hybrid network that brings different technologies together, in accordance with an embodiment of the present invention;

FIG. 2 illustrates an exemplary peer-to-peer network for emergency personnel, in accordance with an embodiment of the present invention;

FIG. 3 illustrates the digital hierarchy of an exemplary synchronous optical network, in accordance with an embodiment of the present invention;

FIG. 4 illustrates an exemplary crime map that may be broadcast through a communication system, in accordance with an embodiment of the present invention;

FIG. 5 illustrates an exemplary process for a user to use an Intelligence Communication Entry (ICE) site, in accordance with an embodiment of the present invention;

FIG. 6 illustrates an exemplary process for the function of an ICE site before entry by a user, in accordance with an embodiment, of the present invention;

FIG. 7 illustrates an exemplary process for using a webcam ATM, in accordance with an embodiment of the present invention;

FIGS. 8a and 8b illustrate exemplary webcam phones, in accordance with embodiments of the present invention. FIG. 8a illustrates an exemplary drive-up or stand-up webcam phone, and FIG. 8b illustrates an exemplary webcam phone in a booth; and

FIGS. 9a, 9b and 9c illustrate an exemplary webcam cell phone, in accordance with an embodiment of the present invention. FIG. 9a is a front view, FIG. 9b is a back view, and FIG. 9c is an interior view.

Unless otherwise indicated illustrations in the figures are not necessarily drawn to scale.

### SUMMARY OF THE INVENTION

To achieve the forgoing and other objects and in accordance with the purpose of the invention, a communication system is presented.

In one embodiment, a communication system for law enforcement and emergency personnel. The system includes a communications provider for providing analog and digital transmissions over a hybrid network including a plurality of transmission means. A blended call center disseminates and receives information related to a crime. The blended call center includes media applications for law enforcement and emergency personnel to communicate information over the hybrid network. A crime classification system is in communication with the communications provider and the blended call center for tracking and classification of crimes to provide intelligence information. A plurality of mobile communication devices, for use by law enforcement and emergency personnel, are capable of sending and receiving messages over the hybrid network. A broadcasting means broadcasts information related to crimes over the hybrid network. An Internet site, accessible via the communications provider, provides secure access to intelligence information. A conference monitor for establishing a media conference with an operator at the blended call center is provided. And, a server is in communication with the blended call center, wherein users of the communication system can access information for dissemination or receiving. In further embodiments, the blended call center further includes a 911 call center and a plurality of 911 call centers are in communication with the blended call center. Further embodiments include a peer-to-peer file sharing network and the hybrid network connects a plurality of government agencies. In another embodiment, the Internet site provides an e-commerce application. In still another embodiment, the broadcasting means further broadcasts information related to crimes in progress. In other embodiments, the plurality of mobile communication devices includes police radios, the communication system further includes a plurality of cell phones with conferencing capability for communicating over the hybrid network and the plurality of cell phones further includes video capabilities. In still other embodiments, the conference monitor provides public information, public access to Internet sites and banking functions.

In another embodiment, a communication system for law enforcement and emergency personnel is presented. The system includes means for providing analog and digital transmissions over a hybrid network including a plurality of transmission means, means for providing a blended call center to disseminate and receive information related to a crime, means for providing a crime classification, means for providing a plurality of mobile communication devices, capable of sending and receiving messages over the hybrid network, means for broadcasting information related to crimes over the hybrid network, means for providing secure access to intelligence information, means for establishing a media conference with an operator at the blended call center, and means for users of the communication system to access information for dissemination or receiving. Further embodiments include means for providing a peer-to-peer network and means for providing cell phones for communicating over the hybrid network.

In another embodiment, a communication system for law enforcement and emergency personnel is presented. The system includes a communications provider for providing analog and digital transmissions over a hybrid network including a plurality of transmission means. A blended call center disseminates and receives information related to a crime. The blended call center includes a 911 call center and media applications for law enforcement and emergency personnel to communicate information over the hybrid network. A plurality of 911 call centers is in communication with the blended call center. A peer-to-peer file sharing network allows law enforcement and emergency personnel to share files over the hybrid network. A crime classification system in communication with the communications provider and the blended call center provides tracking and classification of crimes to provide intelligence information. A plurality of mobile communication devices, for use by law enforcement and emergency personnel, are capable of sending and receiving messages over the hybrid network. A plurality of cell phones with conferencing capability communicates over the hybrid network. A broadcasting means broadcasts information related to crimes over the hybrid network. An Internet site, accessible via the communications provider, provides secure access to intelligence information and an e-commerce application. A conference monitor establishes a media conference with an operator at the blended call center. And, a server, in communication with the blended call center, provides users of the communication system access to information for dissemination or receiving. In further embodiments, the conference monitor provides public information, the conference monitor further provides public access to Internet sites and the conference monitor provides banking functions.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

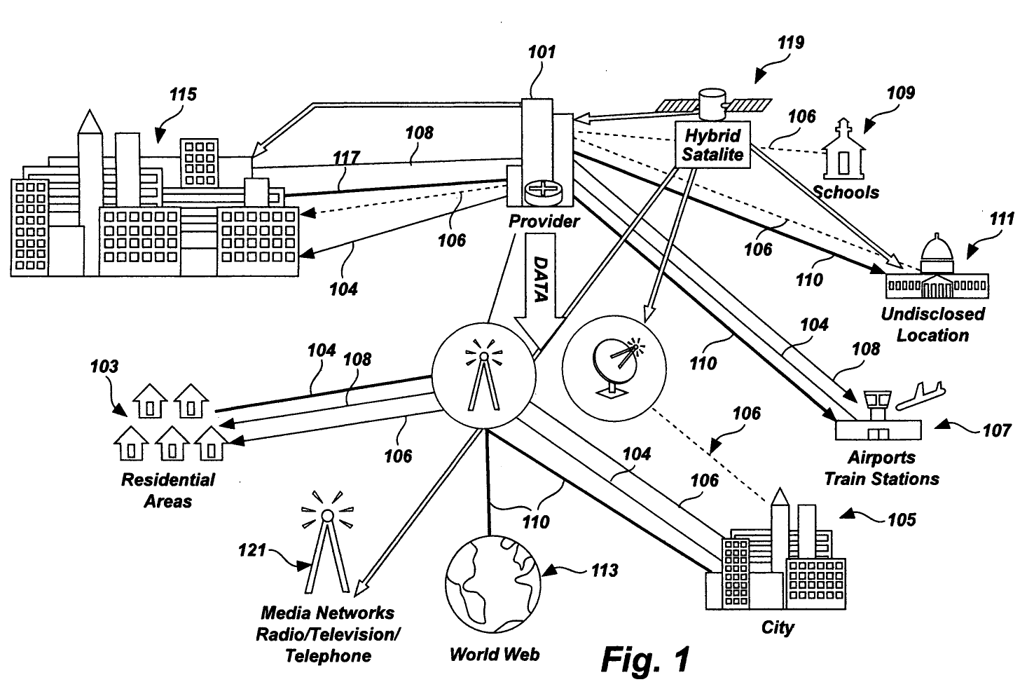

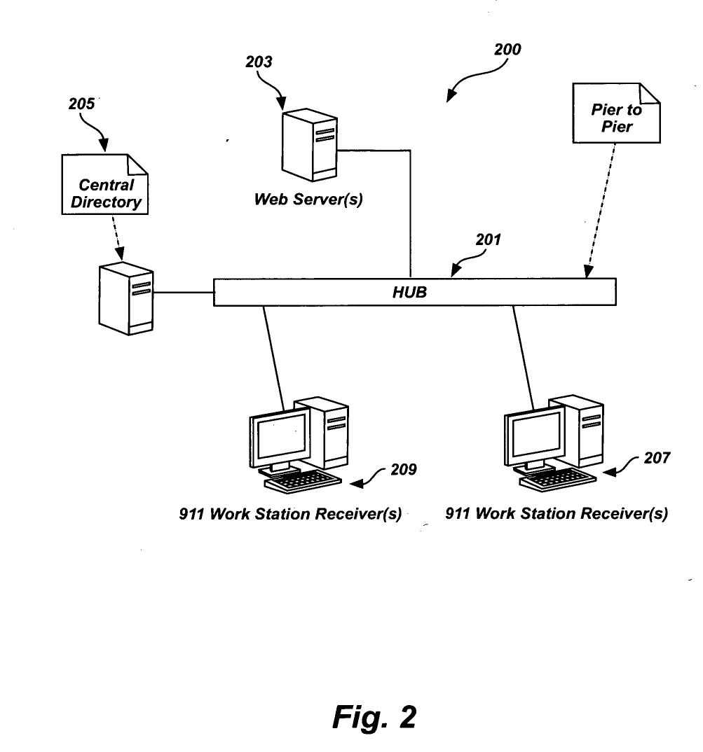

In accordance with embodiments of the present invention, there is provided software applications and databases that utilize various media applications. For example, without limitation, 911 call centers may be linked into a multi area media network, as shown by way of example in FIG. 1 and FIG. 2. Also, those who are involved in a network according to an embodiment of the present invention can share encrypted information. The encrypted information can be shared by means such as, but not limited to, a secure chartroom, by e-mail or encrypted file sharing, as shown by way of example in FIG. 2. A secure chat room is defined as a chat room that is not publicly accessible. Using embodiments of the present invention, only those involved in the network can be involved in secure chat rooms. All persons involved in a communication system according to embodiments of the present invention can be involved in a private Internet provider or a public Internet provider depending on what system is required for the available resources. Embodiments of the present invention can function with private or public worldwide Internet applications. In some embodiments, the system has the ability to provide information to external media outlets and providers using the process.

Some embodiments of the present invention provide a local, national and global system whereby the public can be notified of criminal activity to apprehend criminals and terrorists and gather intelligence. Some embodiments also provide pet alerts or notices when a pet is lost or dislocated from pet owners. Embodiments of the present invention use a multi media network to disseminate information and intelligence and data mine information.

Some embodiments of the present invention provide a peer-to-peer file-sharing network that government entities can use to disseminate and share information easily. Other embodiments provide intelligence communication through the Internet that enable intelligence operatives and law enforcement officers to share information and gather information that can include, without limitation, secret codes, languages, steganography, stegotext, cryptography, and encryption.

Some embodiments of the present invention provide a hybrid network of analog and digital technologies-wireless technologies to create a worldwide network, a network that can use a synchronous optical network (SONET/SDH, synchronous digital hierarchy, terrestrial paging network with satellite interconectability, personnel digital cellular, wireless local loop, media satellites, spy satellites).

Some embodiments of the present invention also provide a paging system for emergency personnel. Embodiments of the present invention also provide means for cell phone web conferences. Some embodiments provide web conference booths. Some of these web conference booths comprise touch screens to file police reports and some web conference booths comprise cameras. Embodiments of the present invention provide web conference banking and ATM's combined that may include features such as, but not limited to, auctions anywhere in the world. Embodiments of the present invention also provide means to conduct web conferences in various locations such as, but not limited to, vehicles, on land, sea, or air for law enforcement or public in any capacity needed.

FIG. 1 illustrates an exemplary hybrid network that brings different technologies together, in accordance with an embodiment of the present invention. The present embodiment uses a hybrid transmission system of analog, satellite and local area network (LAN), WIFI, SONET/SDH, synchronous digital hierarchy, terrestrial paging network with satellite interconnect ability, personnel digital cellular, and/or wireless local loop. The present invention uses synchronous optical networks (SONET) or various technologies such as, but not limited to, satellite, analog, the web, the internet, LAN, WIFI, cell phone towers, and radio towers. A hybrid satellite performs different tasks such as media functions, cell phone, satellite radio, pocket pc's, wireless banking however during this process any satellite may be incorporated. A hybrid system is preferably used because every country and part of the world may have different technology. For example, without limitation, in the event of a pandemic that is discovered as intentional or not intentional, information concerning the pandemic must be released to the public in a timely manner as to not cause panic and to inform and safeguard life and liberty. For this reason hybrid systems have been chosen as they can include various communication systems. The technology in the present embodiment may utilize any technology to warn the public or save lives. Thus the present embodiment may be a worldwide hybrid network. The preferred method for creating the network is fiber optics; however analog connections may also be included in the system. The present embodiment may utilize computer telephony because it is a hybrid system-network; however alternate embodiments are not limited to using computer telephony. The hybrid system according to the present embodiment utilizes many technologies, for example, without limitation, audio, text, voicemail, multipurpose Internet mail, international record carriers, virtual private networks, voice of Internet protocol, communications software, paging networks, SONET/SDH, synchronous digital hierarchy, terrestrial paging network with satellite interconnect ability, personal digital cellular, wireless local loop. Digital technologies are preferred to analog; however, analog is still used in some applications, thus a hybrid system is utilized.

In the present embodiment, a provider 101 provides information to various entities in the network through the various technologies available through the hybrid network. For example, without limitation, provider 101 in the present illustration transmits and receives information to residential areas 103, a city 105, airports and train stations 107, schools 109, and undisclosed locations 111 through fiber optic connections 104, Ethernet connections 106, and analog connections 108. In the preferred embodiment, the fiber optic connection is a 155 Mbps ATM over SM Fiber, TCP/IP; IPX; the Ethernet connection is a 10 Mbps Ethernet (10Base-T); TCP/IP; IIPX; and the analog connection is a 0.28 Mbps Analog over Phone; TCP/OP. However, those skilled in the art, in light of the present teachings will recognize that various alternate types of wireless-connections that may be used, including, but not limited to LAN, WIFI, and Satellite. Data over SONET/SDH architecture, general framing procedure but is not limited to these procedures. In the present embodiment, provider 101 also transmits and receives information from the World Wide Web 113 through an OC-768 Gbps fiber optic connection 110. Various alternate embodiments may use other types of connections such as, but not limited to, other fiber optic connections, Ethernet connections, etc. to connect to the World Wide Web 113. In the present embodiment, city 105, airports and train stations 107, and undisclosed locations may also be connected to provider 101 through an OC-768 Gbps fiber optic connection 110.

In the present embodiment, provider 101 is also connected to multiple call centers 115 through various means. These means include, but are not limited to, multiple T Lines 117, fiber optic connections 104, Ethernet connections 106, and analog connections 104. In the present embodiment, one of call centers 115 is a main blended call center that utilizes various media applications and software. A blended call center is a call center that enables agents to both make and receive calls as demand and strategy dictate. Combining automatic call distribution for incoming calls with predictive dialing for outbound calls, it makes more efficient use of an agent as each can handle the overflow of the other. The main blended call center utilizes various phone lines to receive and disseminate information including, but not limited to, information using a synchronous optical network (SONET). In the present embodiment, the blended call center has an onsite TV and radio station with cell phone locator E-911. The main call center is connected to other call centers that are preferably connected by private or public Internet.

In addition to the various connections means previously described, provider 101 may also transmit and receive information from various entities through hybrid satellites 119. For example, without limitation, in the present embodiment provider 101 may transmit information through hybrid satellites 119 to call centers 115 and undisclosed location 111. Also, provider 101 may receive information through hybrid satellites 119 from media networks 121 including, but not limited to, radio, television and telephone networks. Provider 101 may also receive information through hybrid satellites 119 from undisclosed location 111. These are examples of connections between provider 101 and hybrid satellites 119, and many other entities may also share information with provider 101 through hybrid satellites 119 such as, but not limited to, law enforcement entities and governmental entities.

FIG. 2 illustrates an exemplary peer-to-peer network 200 for emergency personnel, in accordance with an embodiment of the present invention. In the present embodiment, peer-to-peer network 200 can use SONET to bring different technologies together. The peer-to-peer network can transfer information such as, but not limited to, files, media, video, pictures, word documents, PDF files, etc. in emergency situations or in other situations. The users connect through a hub 201 when the other user accepts the information it is transferred to other user. A pass code is typically required to enter peer-to-peer network 200 and may scramble or encrypt such information that only users have software to unscramble. Hub 201 is maintained by web server(s) 203 and has a central directory 205. Central directory 205 comprises information about the users in peer-to-peer network 200. The directory may store files, music, pictures, web-phone-booth cam conversation, and conversations. Peer-to peer network 200 comprises various workstations that may be a workstation sender 207 or a workstation receiver 209. Preferably, the present embodiment is used by emergency personnel or government officials only, and all 911 centers in the United States are connected through a hub such as, but not limited to, hub 201. In some embodiments, peer-to-peer network 200 may also comprise multiple databases to store various types of information, such as, but not limited to, crime statistics, maps, etc.

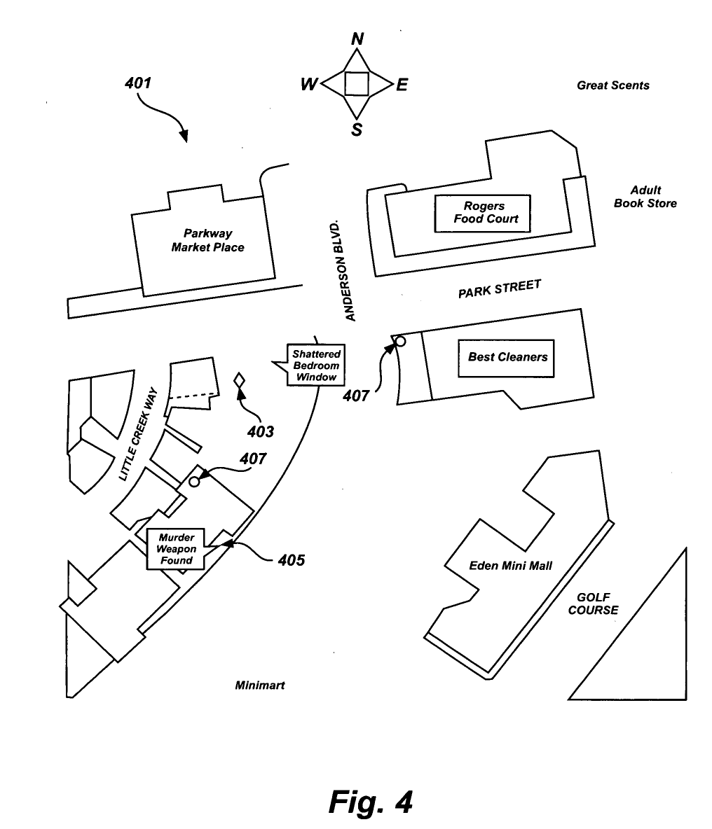

A multiplicity of software applications and databases that utilize various media applications may be implemented. All 911 call centers are linked into a multi area-media network FIG. 1 (also in FIG. 4). Those who are involved in the network can share encrypted information. The encrypted information can be shared by but not limited to a secure chartroom by e-mail or with encrypted file sharing (see FIG. 4). Secure chat room is defined as not public accessible, only those involved in the network can be involved in the chat rooms. All those involved in the system can be involved in a private Internet provider or public Internet provider depending on what system is required for available resources. The system can function with private or public world wide Internet applications. The system has the ability to provide information to external media outlets and providers using the process.

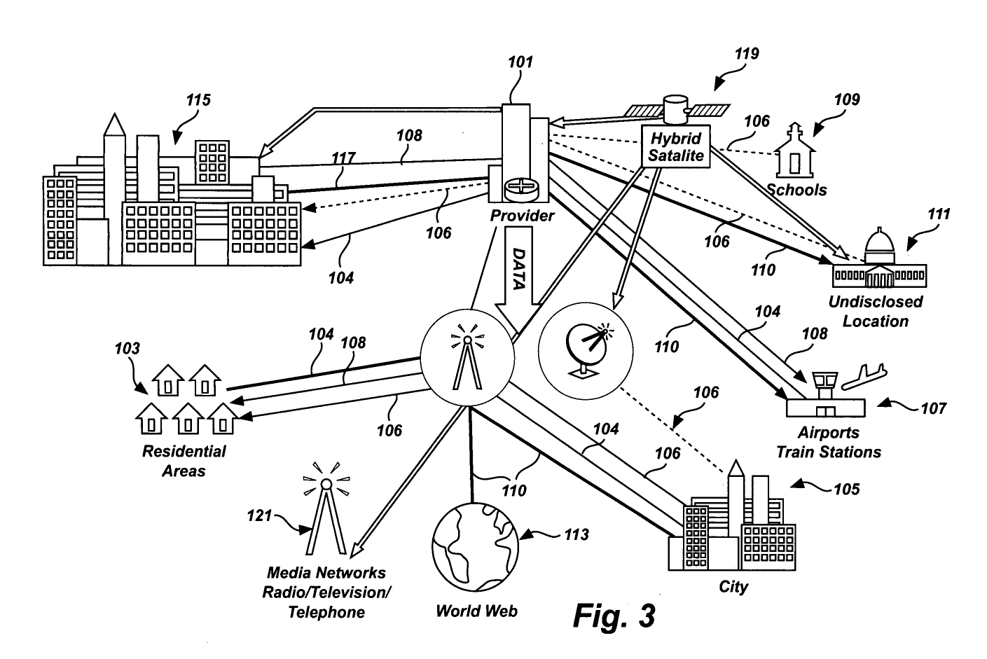

FIG. 3 illustrates the digital hierarchy of an exemplary synchronous optical network (SONET), in accordance with an embodiment of the present invention. The present embodiment works as a subscription service to transform various technologies and bring different networks together. The network can be used by wireless networks and uses fiber optics as well. The network can also transfer analog to digital as a subscription service. The present embodiment comprises a local exchange carrier network 301. Local exchange carrier network 301 receives information from users including, but not limited to, wireless user 303. Wireless user 303 may connect to the network through devices such as, but not limited to, handheld devices, cell phones, pocket PCs, automated teller machines (ATMs), etc. The present embodiment also comprises an internet engineering consortium network 305 with a mobile identification number 307, a generic framing procedure overhead 309, a VCG channel 313, and a synchronous optical network terminal 311. Synchronous optical network terminal 311 has a generic framing procedure. The Synchronous optical network/SDH works if two different carriers the SONNET/SDH/OTN networks are controlled by different providers you could send general framing procedures and certain provisioning commands with client management frames. A inter exchange carrier can provide customer premise equipment and rely on the local exchange carrier to provide a connection between multiple carriers. The local estrange carrier can connect customer premises equipment and inter exchange carrier networks, this can be used on wireless cell phones, automated wireless teller machines, and web cell phones, any wireless device, digital radio and hi definition radio.

The preferred embodiment of the present invention is a communication system that may be used for various purposes such as, but not limited to, catching criminal offenders and law violators, crime classification, and crime intelligence. Multiple users can use the communication system to disseminate information or receive information. The communication system is symmetrically connected to central servers to provide a blended call center to disseminate and receive information such as, but not limited to, information about a crime. The blended call center comprises media applications that enable law enforcement to communicate with the public directly and indirectly through a synchronous optical network (SONET), shown by way of example in FIG. 3, hybrid technologies, shown by way of example in FIG. 1, or a multiple area network. In some embodiments, the blended call center comprises a 911 call center. Preferably, the blended call centers have an onsite TV and radio station with cell phone locator E-911. The call centers may use one site broadcasting or multi site broadcasts.

The communication system comprises means for a macro level multi media provider and a provider of internet and communications. This network may be connected on the international, federal, and state level depending on need. The media applications provided by the network include, without limitation, internet, cell phones, radio, TV communication, hybrid satellites, and hybrid networks. In the present embodiment, the communication system is rigidly connected to the multi media provider.

The communication system according to the preferred embodiment also comprises means for the tracking and classification of crimes from several sources such as, but not limited to, medical examiners, the public, police, 911 centers, and hospitals. The communication system seeks to gather the information from 911 centers, hospitals, medical examiners, and private physicians to provide more accurate crime figures. The information gathered at these locations is data mined. The gathering of information from medical records to see if suspects were in the hospital or to help if victims were in the hospital in investigations, from all listed medical personnel, the information from 911, such as calls to track crimes reported, I guess also if district attorneys (or court personnel) could be involved in the system they could link into a function of 911 and give convictions and clearance rates, 911 could have the ability to log false calls, this info. Would be data mined to get more accurate crime figures and help with criminal, terrorist profiling, its not used for billing or accounts at all, medical staff would partake and enter a data base that could be data mined a universal or local data base with the information that law enforcement would have access to.] All 911 call centers are linked into a multi area hybrid networks, and those who are involved in the network can share encrypted information. The system uses a hybrid satellite and hybrid networks that utilize digital technologies as well as analog. Also, by tracking the complaints or crime discoveries in various fashions, the communication system can create multi crime intelligence reports. Law enforcement may also gather data directly from the public to include in the reports.

The preferred embodiment also comprises means for a broadcast system that utilizes various means of broadcast including, but not limited to, a televised broadcast, media satellites, and internet or cellular broadcast systems. The broadcast system enables broadcasts to be sent to various locations such as, but not limited to, an airplane, airport, school, church, stadium, or any other place needed or requested. These broadcasts may show alerts such as, but not limited to, crime alerts, lost pet alerts, and lost-stolen property alerts. These broadcasts may also show other types of information such as, but not limited to, pictures of wanted criminals, advertisements, or audio warnings.

In the preferred embodiment, this broadcast can also be archived information for broadcast at a later time. In some embodiments, these broadcasts may utilize a cell phone that is identified by a special ring tone. In the event of simultaneous broadcast, solo broadcast programming may be interrupted depending on the severity of advisory. In some instances the representation may be announced of depicted during a programming break.

Some embodiments of the present invention provide the ability to have web conferences with emergency personal, and the ability to communicate with a web camera or web conference in a blended call center or undisclosed location. The conference may be done, for example, without limitation, by cell phone, walkie-talkie radio, handheld device, web booth, or monitors installed in vehicles or secured on land or sea. In typical use of a web conference system, instead of calling 911 the user may press an emergency button to broadcast, to communicate to 911, or make a police report. The user may also call 911 and show images or live feeds to 911 operators. When not in use, the web conference monitors may display information such as, but not limited to, wanted criminals, advertisements and play audio warnings. Some embodiments may also rotate pictures of lost pets or lost-stolen property. The display is controlled by the call center(s) or emergency personnel. The various functions performed by the system can be one at a time or simultaneous.

Communication systems according to various embodiments of the present invention comprise software for a plethora of applications that may include but are not limited to: audio video mastering, audio video editing, audio video converters, digital or analog recording, volume stabilization, vocal remover, vocoder, on air audio block, music and program scheduler, search engines, disaster plan and recovery, Morse code, 10 codes, cd-dvd-ripper, fm or mono stereo, drag and dropping of audio or video files to current play list or future play lists, automated or satellite broadcasts, audio-video effects, black and white broadcasts for a retro effect, production bundles for TV or radio, multistation-multichannel broadcasts options, web recording, operation chartroom or web conferencing, DVD quality broadcasts, 24-72 hour program blocks, picture save, video terrestrial television, video fonts and graphics, picture fonts and graphics, multilingual capability fonts, back ground music generator, telephone recorder for live or prerecorded playback, bulk email and text message, and bulk phone contacts.

As previously described, some embodiments provide technology and a process that provides alerts for lost pets. An alert is defined as a multi media broadcast of various media such as, but not limited to, cell phone communications, TV, radio, handheld devices, and Internet that a pet is missing, has been found living or has expired. Alerts may also broadcast that a dangerous animal is on the loose or that an animal is wandering in land or sea. The animal(s) are profiled and described, and in some instances, programming is stopped and broadcast; however, broadcasts will not be stopped for every event. In an event such as, but not limited to, a disaster, the pets are put on TV in rotation with descriptions of markings and the location found after an event has occurred. In the event the pet is missing, reward information is also provided if available on a multi media communication application.

Some embodiments also provide an auto alert for missing cars and other property crimes. A property crime alert is defined as a multi media communication conveyed to the public when an item is missing with the description of the item and the suspect description if available. A non-limiting example is “This is a property crime alert a stolen 2006 BMW with tag number 567RW from Wyandotte County Kansas was stolen from 727E. Parkwood a physical description of the suspect is not available.” Then the public may communicate to the blended call center and provide information: Or a single call center may broadcast the information or relay the information to other media outlets.

FIG. 4 illustrates an exemplary crime map 401 that may be broadcast through a communication system, in accordance with an embodiment of the present invention. In the preferred embodiment of the present invention a map such as, but not limited to crime map 401 may be broadcast to various people for example, without limitation, the public, emergency personnel, and law enforcement. In the present example, map 401 comprises information such as, but not limited to, a crime location 403, a location of a weapon 405, and locations of witnesses or suspect 407.

Map 401 may be broadcast through various means such as, but not limited to, ATMs, cell phones, digital radios, analog radios, police radios, car radios, stadiums, taxis, electronic billboards, satellite radio, TV, hand held devices, wristwatches, etc. Depending on the means for broadcast, map 401 may be accompanied by audio or video detailing the crime. This can be done with software or SONET, through cable or internet, using various software applications.

An embodiment of the present invention incorporates a paging system that utilizes police radio with wireless technology or satellite into a communications system. The radios have paging systems built in. The paging systems are included in the hybrid system and may also enable the use of cell phones. In the present embodiment, the police radio pagers and or cell phones display messages in the police vehicles, mobile radios and cell phones. The paging system may utilize various technologies such as, but not limited to, cellular technology to send information such as, but not limited to, images, voice, and e-mail to warn the public of a crime or crisis. In typical use of a paging system in an emergency vehicle, the message is broadcast in the same way. The paging system can also be used amongst law enforcement officers because it has a keypad to communicate back and forth for text and paging. This is built into the hybrid system. Paging systems in vehicles are part of the mounted radio. In the event that an officer needs to communicate, he uses the hand held radio. Because the radios are small to many features would way it down. The radios currently have space to include a keypad and circuitry to receive text messages with a lens to take pictures or use web conferences. In a case where an officer does not want others to hear the broadcast, the dispatch can use the paging system to text message the officer with a message or image. Dispatch may use a 10 code to announce the text message or response. These paging systems can be installed in undercover vehicles, and, in some embodiment, they can be mobile as to not attract attention to the use of the radio.

In an alternate embodiment paging technology may be used in business and vehicles. Some non-limiting examples of the use of paging systems follow. In one example, an offender steals a police vehicle, and the control center(s) may use paging technology to lock the vehicle so the offender cannot exit the vehicle easily. In another example, a mass murder is in a school, and the paging technology locks the offender in a certain part of the building. In another example, a correctional facility riot occurs, and the correctional facility locks the whole cell house down from a control center or another location the whole time using 10 codes and communicating with staff over the paging system.

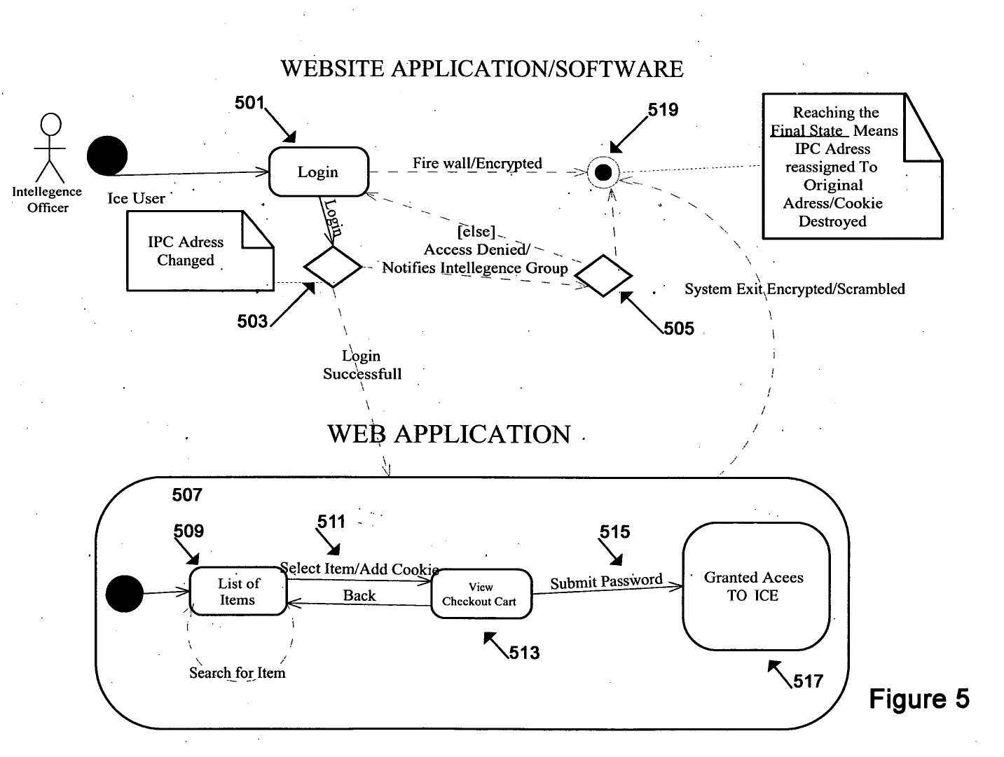

FIG. 5 illustrates an exemplary process for a user to use an Intelligence Communication Entry (ICE) site, in accordance with an embodiment of the present invention. In the present embodiment, the ICE site disseminates information to intelligence operatives. The ICE site is disguised as a legitimate business. In the present embodiment, the operative, or intelligence officer begins by visiting a designated screen on the ICE site and places a code or entry on the ICE site to login in step 501. The site functions differently for different populations. For instance, without limitation, an operative's code enables him to get information or disseminate information to and from the ICE site. A consumer has access only to the business function of the ICE site, for example, without limitation, to purchase a product or check on a status of an order. The general public is not aware of the operative function of the ICE site, and thus the operative is protected. If login at step 503 is unsuccessful, access to the site is denied, and the intelligence group running the ICE site is notified in step 505, and the user is returned to the login screen, step 501. If login is successful in step 503, the user is allowed access to a web application 507. The ICE site can change the passwords to protect intelligence and operatives.

In the present embodiment, web application 507 looks like an ordinary business site on the Internet; however, the ICE site is a software application with a web portal. When a user tries to access the portal, an intelligence agency is notified in real time and can monitor the activity of the user or destroy the ICE site using software. When a user is granted access to the site, the user can download information such as, but not limited to, images, audio for secret codes, languages, steganography, stegotext, cryptography, and encryption. It may look as simple as a purchase of a downloadable DVD movie; however, the movie may contain steganography that the operative may destroy by means of incineration or paper shredder. Once a user accesses web application 507, the user browses a list of items in step 509. This step may be repeated as needed until the user finds the item for which he is searching. In step 511, the user selects an item and a cookie is added. The user's computer who logged in this would be done to the user's computer after the previous cookie was destroyed. The user views the checkout cart in step 513 to determine if the correct item has been selected. If not, the user may return to step 509 to search the list of items again. If the item is correct, the user submits a password or code in step 515, and if this password is correct, is granted access to the ICE site in step 517, where the item is sent or downloaded to the user(s).

There are various methods utilized to disseminate information. In the present embodiment, the ICE site is connected in a multi area network or by Internet. The user can also chat via a secure chat room or upload information. Upon exiting the ICE site, the information disseminated is encrypted or scrambled. When the user leaves the ICE site in the final state, step 519, the cookie is destroyed, the IPC address is reassigned, and the user replaces their hard drive. In the present embodiment, the hard drive the user has on their device is removable or they are trained to remove the hard drive of such used device. The replaced hard drive may be packaged with the software of the previously removed hardware, giving no clue of possible intercepted device. Each user is trained how to smuggle and destroy such removable hard drive on handheld devices, computers or cell phones. In the present embodiment, these secret operations are controlled in a call center or an undisclosed location and are hooked into the process. This function is not accessible to the public and is TOP SECRET.

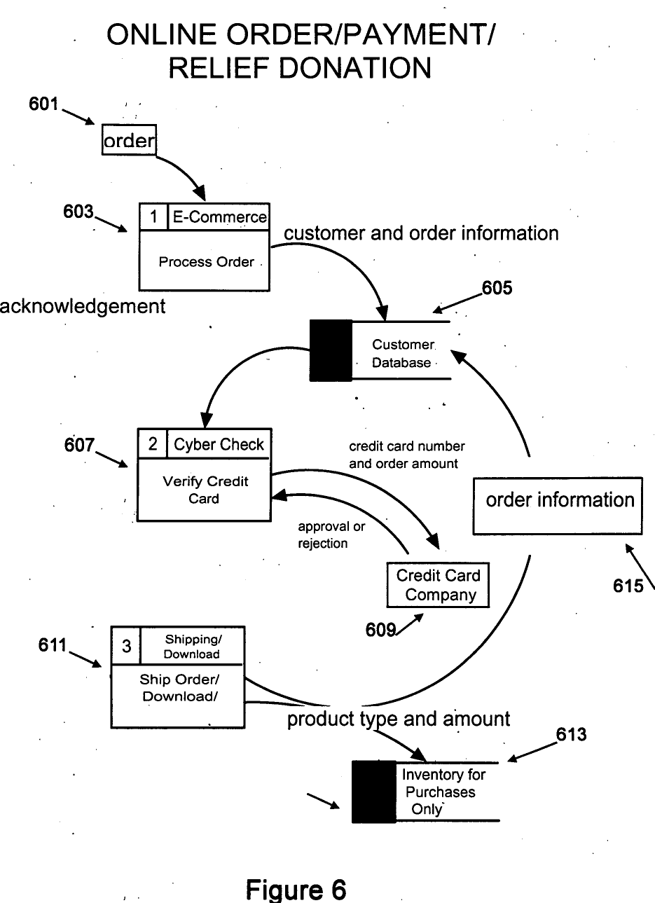

FIG. 6 illustrates an exemplary process for the function of an ICE site before entry by a user, in accordance with an embodiment, of the present invention. In the present example, the ICE site functions as a product-purchasing site; however, in actuality the site is downloading sensitive data. The present embodiment begins when a customer places an order with his computer in step 601. Then, in step 603, the site processes the order, and sends an acknowledgement of the order to the customer's computer. In step 605 the site retrieves customer and order information from a customer database. In step 607, the customer's credit card is verified by sending credit card and order information to the credit card company. The credit card company then approves or rejects the order in step 609. The order is then shipped to the customer or downloaded by the customer in step 611. Information concerning the product type and amount sold is then sent to an inventory database in step 613, and order information is sent to the customer database in step 615.

In an alternate embodiment, the communication system may be used to create an eCommerce site to collect money after disaster for charity. This eCommerce site allows media downloads and uploads and the shipment of physical material goods.

Currently, banking systems exist; however, people usually drive to those locations, and this poses a problem for users on foot who may not have vehicles. In instances such as, but not limited to, an emergency credit cards may be stolen or there may be identity theft or loss. With banking systems according to the present embodiment, bankers can see patrons and get to know bank patrons via web conference booths, and identification becomes easy. When large amounts of money are transferred between accounts identity can be established and recorded for legal reasons. Furthermore, these transactions are not restricted to any part of the world. The present embodiment may also provide means for users to participate in online auctions such as, but not limited to, EBAY.

An embodiment of the present invention provides a web communication booth that allows various functions such as, but not limited to, email, banking, auctions, the ability to fill out police reports, and the ability to communicate anywhere with web conferences. The present embodiment also can play audio and rotate images, such as, but not limited to, crime alerts and includes an Automated Teller Machine (ATM) with a touch screen and audio communication between users. In the present embodiment, a web ATM has internal hard drive, graphics card and sound card. A user is connected to a bank web agent or other entity through the Internet or wirelessly. Such a user communicates through a speaker microphone. The user is visible to bank staff for transactions because the ATM includes, without limitation, a webcam. The user is given money through a slot or may digitally transfer money. In some embodiments, the ATM can operate without live interaction as an option. The ATM comprises the same components as a computer; however, the ATM may additionally be prompted remotely to disseminate cash by bank personnel. Embodiments of the present invention may be placed in various locations such as, but not limited to, booths, automobiles, trains, airports or anywhere else needed.

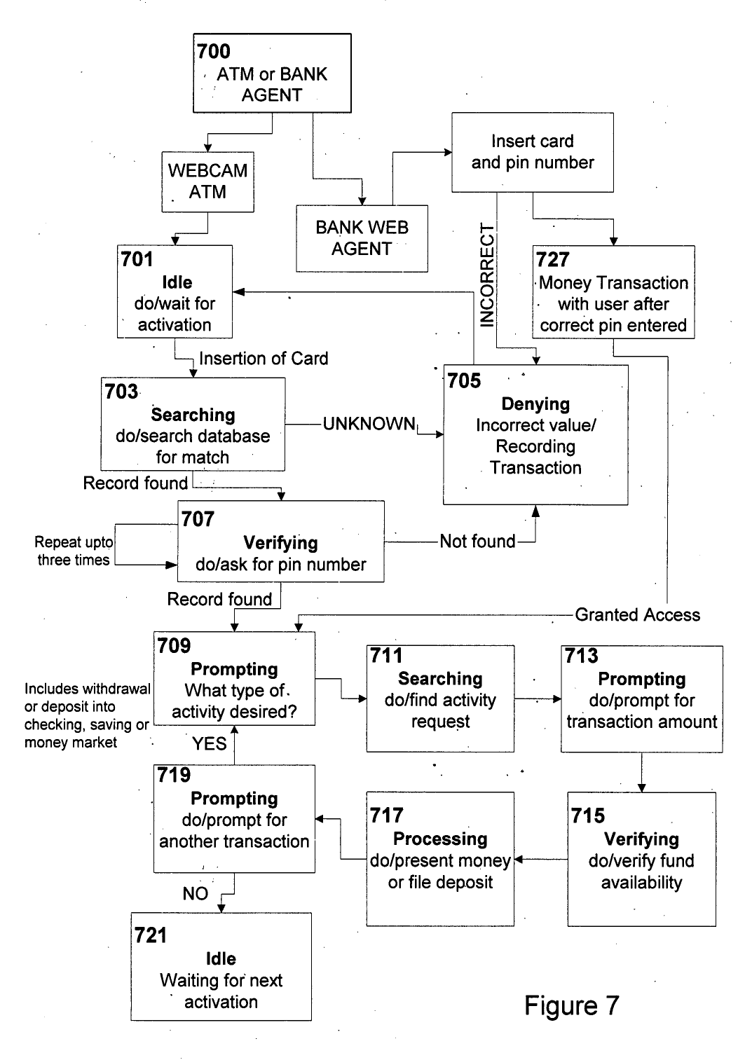

FIG. 7 illustrates an exemplary process for using a webcam ATM, in accordance with an embodiment of the present invention. The ATM can function with the use of a bank agent or webcam and can be prompted to give money or transfer money without live contact. To begin, in step 700, a user decides if he wishes to use the ATM or speak to a bank web agent. If the user wishes to use the ATM, the process continues to step 701. In step 701, the ATM is idle, waiting for a user to activate it by inserting a card. Once a card is inserted in step 703, the ATM searches a database for the card information. If the card is unknown, the ATM denies the user and records the transaction in step 705 then returns to step 701. If a record of the card is found, the ATM verifies the user by asking for a pin number in step 707. In the present embodiment, this step may be repeated up to three times. If the pin number is incorrect, the user is denied in step 705, the transaction is recorded, and the ATM returns to step 701. The ATM prompts the user with options for types of transactions available in step 709. These options include, without limitation, withdraw or deposit into various types of accounts such as, but not limited to, checking, savings, and money market accounts. In step 711 the ATM searches for the activity requested by the user. In step 713 the user is prompted to enter an amount for the transaction. Then, the ATM verifies the transaction for fund availability in step 715, and processes the transaction in step 717. After the transaction is processed, the ATM asks the user if he would like to perform another transaction in step 719. If the user does want another transaction, the ATM returns to step 709 to prompt the user to choose a transaction type. If the user does not want another transaction, the ATM returns to an idle state in step 721.

If in step 700 the user wishes to speak to a bank web agent, the process proceeds to step 725, where the user inserts his card and pin number into the ATM. If the user enters an incorrect pin number, the process proceeds to step 705 where the user is denied access to the web agent. If the user enters a correct pin number, the user is granted access to live help in step 727 where the bank web agent can perform a money transaction for the user. The user may communicate with the bank agent with a webcam via means such as, but not limited to, internet or SONET. The bank agent prompts various options to the user in step 709. These options include, without limitation, the dissemination of money, the transfer of money, or that the whole process is recorded. From this point, the process continues as previously described while the user can ask questions and talk to the live bank agent while performing these steps. Also, the bank agent can see the user because of the webcam and can verify that the user is the owner of the accounts being accessed.

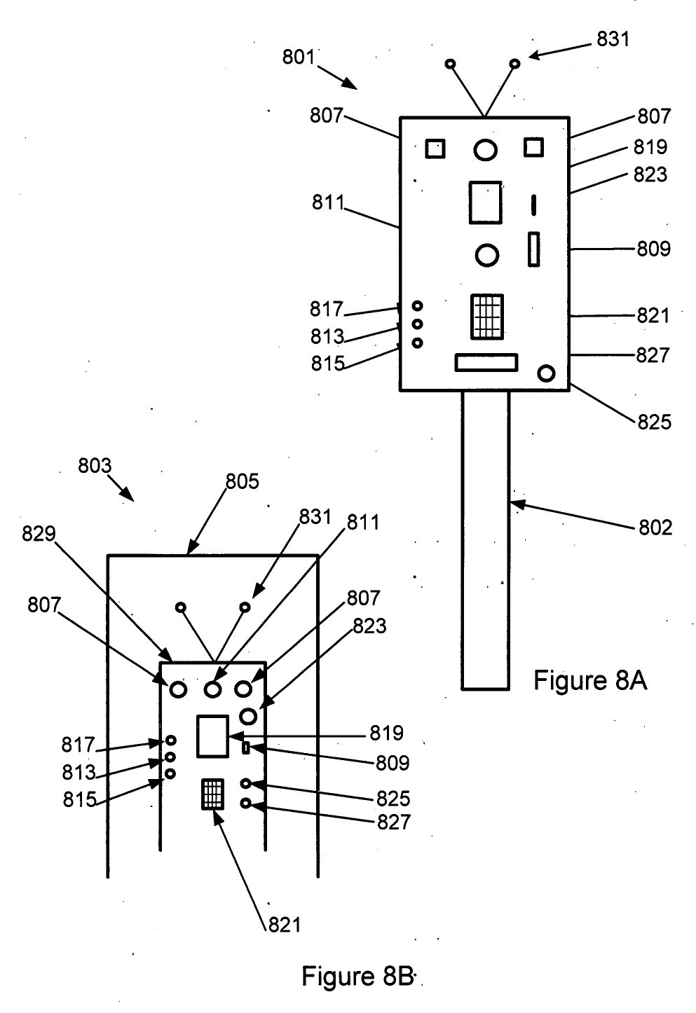

FIGS. 8a and 8b illustrate exemplary webcam phones, in accordance with embodiments of the present invention. FIG. 8a illustrates an exemplary drive-up or stand-up webcam phone 801 supported by a pole 802, and FIG. 8b illustrates an exemplary webcam phone 803 in a booth 805. The present embodiments comprise speakers 807 to listen to other users. Some embodiments may also have an earphone jack into which the user can insert earphones for listening. In the present embodiments, the user slides a card in to a card slot or slider 809 or, in some embodiments, inserts money into a slot where the card slider is shown. A webcam lens 811 is connected to software or a hard drive 813 and uses a graphics card 815 and a sound card 817 to operate. In the present embodiment, hard drive 813, graphics card 815 and sound card 817 are located in the housing of webcam phones 803 and 805 and are not accessible to users. The present embodiments also comprise a screen 819 and a keypad 821. During typical use a user can see other users on screen 819 and speak into speakers 807, which act as a microphone and disperse audio and receive audio. When connecting to other users, the user enters a number on keypad 821 to connect to other users in various locations including, but not limited to, home, office, etc. The present embodiments also comprise a memory card slot or smart card 823 into which the user can insert a memory card/smart card to download material off of the internet or to record a conversation. A record button 825 is located on the face of webcam phones or other part of the phone 801 and 803. Webcam phones 801 and 803 both comprise a chip 827. The chip stores information downloads of music, images, documents, voice files (record function). The smart card, memory chip, is changeable by design according to manufacturer.

Webcam phone 803, shown by way of example in FIG. 8b, functions the same as webcam phone 801, shown by way of example in FIG. 8a, except that the user can sit in booth 805, or it may be mounted on a wall in a residence where the user can sit. Webcam phone 803 can function absent the card slider in a residence or mounted or manufactured into a automobile for directions or conversations or integrated into a television with described technologies. Webcam phone 803 also has a curtain or door 829 that may be closed by the user for privacy. Both webcam phone 801 and webcam phone 803 are connected to the Internet through means such as, but not limited to, Ethernet, fiber optics or analog connections. The present embodiments also comprise an antenna 831 that enables the webcam phones to function wirelessly.

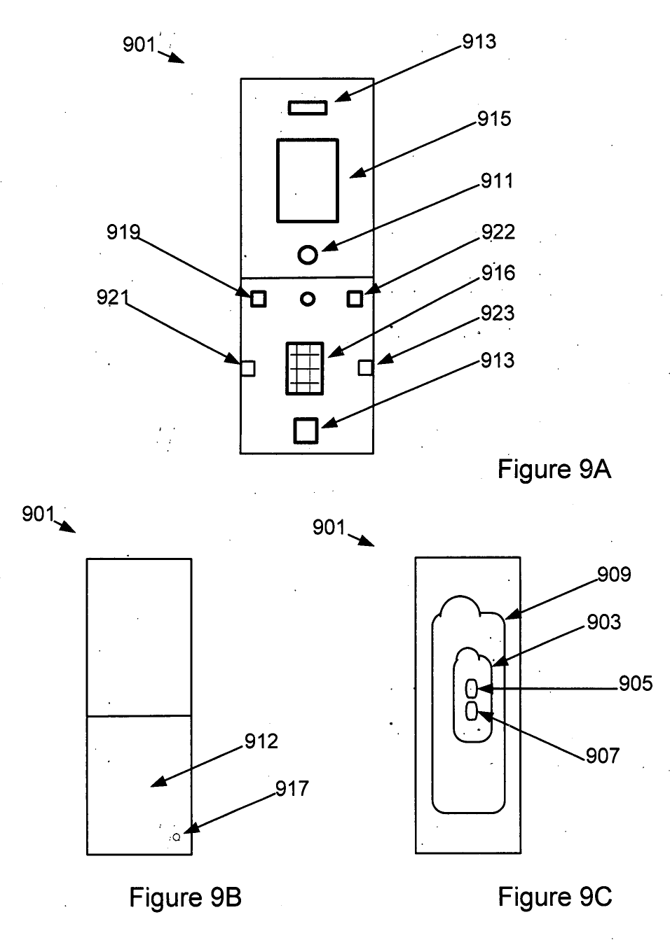

FIGS. 9a, 9b and 9c illustrate an exemplary webcam cell phone 901, in accordance with an embodiment of the present invention. FIG. 9a is a front view, FIG. 9b is a back view, and FIG. 9c is an interior view. The present embodiment may operate through various means including, but not limited to, cell towers, SONET and satellite. Webcam cell phone 901 comprises all of the components of a computer including but not limited to, a hard drive 903, a graphics card 905, a sound card 907, and circuitry 909. The present embodiment also incorporates a lens 911 that is connected to a webcam. Each user can communicate with other webcams such as, but not limited to, an ATM's drive up webcam or residence webcam. Webcam phone 901 It has a subset of chips where the user removes a battery 912. The chips hold information such as, but not limited to, recorded data music. Webcam cell phone 901 has a speaker 913 built into it so that users can hear other users and a mouth feed 915. Webcam cell phone 901 also incorporates a screen 915, a keypad 916, a plug 917 to charge battery 912, and a power button 919. A record chip 921 can hold recorded conversations and music files. Record chip 921 is operated with a record button 922. 921 is removable. A software chip 923 stores software that is transferred to hard drive 903. Software chip 923 is also removable so that the software on hard drive 903 can be changed.

In typical use, a user keeps webcam cell phone 901 on his person, for example without limitation, in his pocket or briefcase until needed. When needed the user can enter a number on keypad 916 to make call's. The user and the party that he is calling, if the called party is using a similar device, can see each other on screen 916 while talking. In alternate embodiments the technology incorporated into webcam cell phone 901 may be incorporated into other handheld devices such as, but not limited to; PDA's and pocket PC's.

Since other modifications and changes varied to fit particular operating requirements and environments will be apparent to those skilled in the art, the invention is not considered limited to the examples chosen for purposes of disclosure, and covers all changes and modifications which do not constitute departures from the true spirit and scope of this invention.

Having fully described at least one embodiment of the present invention, other equivalent or alternative means for implementing a communication system according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A communication system for law enforcement and emergency personnel, the system comprising:
a communications provider for providing analog and digital transmissions over a hybrid network comprising a plurality of transmission means;
a blended call center to disseminate and receive information related to a crime, said blended call center comprising media applications for law enforcement and emergency personnel to communicate information over said hybrid network;
a crime classification system in communication with said communications provider and said blended call center for tracking and classification of crimes to provide intelligence and data mined information;
a plurality of mobile communication devices, for use by law enforcement and emergency personnel, capable of sending and receiving messages over said hybrid network;
a broadcasting means for broadcasting information related to crimes over said hybrid network;
an Internet site, accessible via said communications provider, for providing secure access to intelligence information;
a conference monitor for establishing a media conference with an operator at said blended call center; and
a server, in communication with said blended call center, wherein users of the communication system can access information for dissemination or receiving.

2. The communication system as recited in claim 1, wherein said blended call center further comprises a 911 call center.

3. The communication system as recited in claim 2, further comprising a plurality of 911 call centers in communication with said blended call center.

4. The communication system as recited in claim 1, further comprising a peer-to-peer file sharing network.

5. The communication system as recited in claim 1, wherein said hybrid network connects a plurality of government and private agencies.

6. The communication system as recited in claim 1, wherein said Internet site provides an e-commerce application.

7. The communication system as recited in claim 1, wherein said broadcasting means further broadcasts information related to crimes in progress.

8. The communication system as recited in claim 1, wherein said plurality of mobile communication devices comprises police radios.

9. The communication system as recited in claim 1, further comprising a plurality of cell phones with conferencing capability for communicating over said hybrid network.

10. The communication system as recited in claim 9, wherein said plurality of cell phones further comprises video capabilities.

11. The communication system as recited in claim 1, wherein said conference monitor provides public information.

12. The communication system as recited in claim 11, wherein said conference monitor further provides public access to Internet sites.

13. The communication system as recited in claim 11, wherein said conference monitor provides banking functions.

14. A communication system for law enforcement and emergency personnel, the system comprising:
means for providing analog and digital transmissions over a hybrid network comprising a plurality of transmission means;
means for providing a blended call center to disseminate and receive information related to a crime;
means for providing a crime classification and data mining;
means for providing a plurality of mobile communication devices, capable of sending and receiving messages over said hybrid network;
means for broadcasting information related to crimes over said hybrid network;
means for providing secure access to intelligence information;
means for establishing a media conference with an operator at said blended call center; and
means for users of the communication system to access information for dissemination or receiving.

15. The communication system as recited in claim 14, further comprising means for providing a peer-to-peer network.

16. The communication system as recited in claim 14, further comprising means for providing cell phones for communicating over said hybrid network.

17. A communication system for law enforcement and emergency personnel, the system comprising:
a communications provider for providing analog and digital transmissions over a hybrid network comprising a plurality of transmission means;
a blended call center to disseminate and receive information related to a crime, said blended call center comprising a 911 call center and media applications for law enforcement and emergency personnel to communicate information over said hybrid network;
a plurality of 911 call centers in communication with said blended call center;
a peer-to-peer file sharing network for law enforcement and emergency personnel to share files over said hybrid network;
a crime classification system in communication with said communications provider and said blended call center for tracking and classification of crimes to provide intelligence information;
a plurality of mobile communication devices, for use by law enforcement and emergency personnel, capable of sending and receiving messages over said hybrid network;
a plurality of cell phones with conferencing capability for communicating over said hybrid network;
a broadcasting means for broadcasting information related to crimes over said hybrid network;
an Internet site, accessible via said communications provider, for providing secure access to intelligence information and an e-commerce application;
a conference monitor for establishing a media conference with an operator at said blended call center; and
a server, in communication with said blended call center, wherein users of the communication system can access information for dissemination or receiving.

18. The communication system as recited in claim 17, wherein said conference monitor provides public information.

19. The communication system as recited in claim 18, wherein said conference monitor further provides public access to Internet sites.

20. The communication system as recited in claim 18, wherein said conference monitor provides banking functions.

21. The communication system as recited in claim 1, in which said crime classification system further comprises means for gathering information from a medical records database to help determine if a suspect committed the crime.

22. The communication system as recited in claim 1, in which said crime classification system further comprises, or otherwise has data mining access to, medical, crime statistics, and map databases.

23. The communication system as recited in claim 1, in which said crime classification system further comprises, or otherwise has access to, a multiplicity of databases containing information that is at least potentially useful for classification of the crime, at least some of said databases being data mined by said crime classification system.
